(19) United States
(12) Patent Application Publication
(10) Pub. No.: US 2016/0131782 A1
(43) Pub. Date: May 12, 2016

(54) PARAMETER VARIATION IMPROVEMENT FOR SEISMIC DATA USING SENSITIVITY KERNELS

(71) Applicant: CGG SERVICES SA, Massy (FR)

(72) Inventor: Benoit DE CACQUERAY, Clamart (FR)

(21) Appl. No.: 14/898,032

(22) PCT Filed: Jun. 25, 2014
(86) PCT No.: PCT/EP2014/063434

§ 371 Date: Dec. 11, 2015

Related U.S. Application Data
(60) Provisional application No. 61/840,804, filed on Jun. 28, 2013.

(51) Int. Cl. G01V 1/30; G01V 1/36

(52) U.S. Cl. CPC G01V 1/305; G01V 1/368; G01V 2210/6222

(57) ABSTRACT

Methods and systems for optimizing the quantity and precision of processed seismic data based on reducing destructive interference of the seismic data. Sensitivity kernels are computed based on the medium of interest, e.g., source-receiver pairs, CDP collections and migrated collections, for a preselected wavefield parameter, e.g., travel-time, amplitude, slowness, etc., using a velocity model. Next, wavefield parameters are computed for a selected subset of the medium and are inverted or deconvolved with the sensitivity kernels to generate subsurface parameter variations.

### RELATED APPLICATION

The present application is related to, and claims priority from U.S. Provisional Patent Application No. 61/840,804, filed Jun. 28, 2013, entitled “VARIATIONS PARAMETERS RESOLUTION IMPROVEMENT USING SENSITIVITY KERNELS,” to Benoit CACQUERAY, the disclosure of which is incorporated herein by reference.

### TECHNICAL FIELD

Embodiments of the subject matter disclosed herein generally relate to methods and systems for seismic data acquisition and processing and, more particularly, to acquisition devices based on a propagated wavefield within a medium with more than one source-receiver record.

### BACKGROUND

For many decades multiple source-receiver devices, as described by H. T. Fries on pages 685-707 of his 1925 publication entitled “A New Directional Receiving System,” incorporated herein by reference and by R. M. Foster on pages 292-307 of his 1926 publication in Bell System Technology entitled “Directive Diagrams of Antenna Arrays,” incorporated herein by reference, have been used to improve the quality of data acquisition.

Over time, source and/or receiver array processing has evolved to focus on electromagnetic, acoustic and/or elastic wave energy originating from a single direction. These evolutions are further described for the field of seismology by E. W. Carpenter on pages 1816-1821 of his 1965 publication entitled “An Historical Review of Seismometer Array Development” in The Proceedings of IEEE, incorporated herein by reference and for the field of radio astronomy by M. A. Garrett in his 2012 publication entitled “Radio Astronomy Transformed: Aperture Arrays—Past, Present and Future” in The Proceedings of Science, incorporated herein by reference.

Looking to more recent developments, arrays have been used to enhance the detection of parameter variations within a medium, e.g., velocity variations among others. For example, oceanography applications have been demonstrated in a laboratory scale environment in which a double-beamforming algorithm has been used to track velocity variations in water as described by I. Iturbe, P. Roux, B. Nicolas, J. Virieux and J. I. Mars (hereinafter “ITURBE1) in their publication entitled “Shallow Water Acoustic Tomography Performed from a Double Beamforming Algorithm: Simulation Results,” IEEE Journal of Oceanic Engineering, Volume 34, n. 2, pages 140-149, April 2009, incorporated herein by reference and by I. Iturbe, P. Roux, J. Virieux and B. Nicolas (hereinafter “ITURBE2”) in their publication entitled “Travel-time Sensitivity Kernels versus Diffraction Patterns Obtained Through Double Beamforming in Shallow Water,” Journal Acoustic Society of America, Volume 126, n. 2, pages 713-720, August 2009, incorporated herein by reference.

Looking to FIG. 1(a), the travel-time sensitivity kernel 102 for a signal with a central frequency of 2.5 KHz in constant velocity water is depicted for an oceanographic application such as those described above by Iturbe. The travel-time sensitivity kernel 102 illustrates how the velocity variations of the different regions of a medium impact the travel-time for a given path, i.e., one acoustic or elastic signal traveling from one source to one receiver. It can be seen from the example provided by the different shadings in sensitivity kernel 102 that travel-time sensitivity kernels show that velocity variations occurring in different regions of a medium can have different impacts on travel-time, e.g., in some regions the impact can be generally negative (i.e., velocity increases which result in travel-time decreases) but in other regions, the impact can be null or positive (i.e., velocity increases which result in travel-time increases). The sensitivity kernel 102 depicted in FIG. 1(a) is also known as a “Frechet kernel,” or—due to its particular shape—a “banana-doughnut.” Exhaustive explanations of this phenomenon are described by G. Nolet, F. A. Dahlen and R. Montelli in their publication entitled “Traveltimes and Amplitudes of Seismic Waves: A Reassessment,” AGU Monograph Series, incorporated herein by reference.

The main issue associated with this depiction of the sensitivity kernel 102 is the fact that if a velocity variation occurs on the central path, the sensitivity kernel is null and, consequently, the variation is not seen in the wave. Attempts have been made to correct this condition in the oceanographic context by adding both sources and receivers to the acquisition system and using a double-beamforming summation algorithm as described by ITURBE1 and ITURBE2 to modify the sensitivity kernel.

For example, the sensitivity kernel 102 has been modified, as shown in FIG. 1(b) by the depiction of modified sensitivity kernel 104, based on the use of thirty-two sources and thirty-two receivers with a spacing of 1.5 meters. It is noted that in the modified sensitivity kernel 104 the polarity oscillations are no longer present and that, along the main path, the polarity is always negative. In this context, the double-beamforming used to generate the modified sensitivity kernel 104 allows the behavior to more closely approximate ray theory where rays are approximated by lines. Although described above in the context of travel-time, sensitivity kernels can be computed not only for travel-time, but also for other parameters such as amplitude. Using e.g., amplitude sensitivity kernels, this approach can be adapted to track velocity variations using amplitude changes as described by C. Marandet in his 2011 Ph.D. thesis entitled “Detection and Location of Ocean Wave Guide Target; Application to the Concept of Acoustic Barrier at the Laboratory Scale,” Joseph Fourier University, incorporated herein by reference.

Whereas oceanography seeks to better understand the oceans themselves (including the oceans' floors), seismic data acquisition seeks to image areas of the earth or ocean's subsurfaces in an attempt to locate hydrocarbon deposits. Thus seismic data acquisition typically involves differences in both the system used to acquire data, and in the manner in which the acquired data is subsequently processed. For example, in the case of seismic explorations array processing methods like the double-beamforming algorithm described above are not commonly used. Instead, seismic exploration preferably considers a source-receiver pair, a common-depth point (CDP) collection or migrated traces instead of arrays. In all of these configurations, the corresponding travel-time sensitivity kernels continue to show oscillations around the central ray path. This is highlighted, for example, in FIG. 2(a) which illustrates travel-time sensitivity kernels for a single source-receiver pair 202 and in FIG. 2(b) for a CDP collection 204 in the context of seismic data acquisition instead of the oceanographic context of FIGS. 1(a) and 1(b). FIGS. 2(a) and 2(b) will be described in more detail below. Thus, it would be desirable to adapt the processing of the acquired seismic data to reduce or eliminate the oscillations around the central ray path in seismic sensitivity kernels using a technique other than the beamforming technique of Iturbe which is not well suited for seismic applications.

Accordingly, it would be desirable to provide systems and methods that avoid the afore-described problems and drawbacks, and to provide systems and methods to maximize the available information associated with parameter variations with a given set of source-receiver pairs.

### SUMMARY

These and other aspects are addressed according to various embodiments which, for example, determine subsurface parameter variations associated with sensitivity kernels without using beamforming techniques.

According to an embodiment, a method, stored in a memory and executing on a processor, for seismic data processing, includes the steps of computing at least one sensitivity kernel related to at least one wavefield parameter associated with the seismic data, computing the at least one wavefield parameter associated with the seismic data; and inverting or deconvolving the at least one wavefield parameter with the at least one sensitivity kernel to generate at least one subsurface parameter variation.

According to another embodiment, a method, stored in a memory and executing on a processor, for processing seismic data includes the steps of computing sensitivity kernels associated with source-receiver pairs based on a velocity model; filtering the source-receiver pairs to a predetermined location; adapting the sensitivity kernels to the filtered source-receiver pairs; computing wavefield parameters associated with the filtered source-receiver pairs; and inverting or deconvolving the wavefield parameters with the adapted sensitivity kernels to derive at least one subsurface parameter variation.

According to another embodiment, a system for processing seismic data includes a seismic dataset; one or more processors configured to execute computer instructions and a memory configured to store the computer instructions wherein the computer instructions further comprise: a sensitivity kernel component for computing at least one sensitivity kernel based on the seismic dataset, a wavefield parameter component for computing at least one wavefield parameter based on said seismic dataset; and an inversion or deconvolution component for inverting or deconvolving the at least one wavefield parameter with the at least one sensitivity kernel to generate at least one subsurface parameter variation .

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 (a) shows a travel-time sensitivity kernel for a single source-receiver pair and FIG. 1(b) shows a modified sensitivity kernel resulting from a double beamforming processing of 32 receivers and 32 sources, which are associated with parameter variations (velocity variations in this case) as functions of depth and distance;

FIG. 2(a) shows a travel-time sensitivity kernel associated with data collected for a single source-receiver pair and FIG. 2(b) shows a travel-time sensitivity kernel associated with data collected from nine common depth point (CDP) source-receiver pairs;

FIG. 3 shows various aspects of an onshore seismic data acquisition system whose acquired data can be processed according to various embodiments;

FIG. 4 shows various aspects of another onshore seismic data acquisition system whose acquired data can be processed according to various embodiments;

FIG. 5 shows an exemplary seismic acquisition geometry;

FIG. 6 is a flowchart illustrating a method for seismic data processing according to an embodiment;

FIG. 7 shows various aspects of a signals frequency dependency according to an embodiment;

FIG. 8 shows sensitivity kernels associated with different frequency bands of seismic data;

FIGS. 9 shows other aspects of frequency dependency according to embodiments;

FIGS. 10(a) and 10(b) are flowcharts of methods for processing seismic data according to embodiments;

FIG. 11 is a schematic diagram of software components for implementing embodiments; and

FIG. 12 illustrates an exemplary data processing device or system which can be used to implement the embodiments.

### DETAILED DESCRIPTION

The following description of the embodiments refers to the accompanying drawings. The same reference numbers in different drawings identify the same or similar elements. The following detailed description does not limit the invention.

Instead, the scope of the invention is defined by the appended claims. Some of the following embodiments are discussed, for simplicity, with regard to the terminology and structure of maximizing the available information associated with parameter variations with a given set of source-receiver pairs by avoiding destructive summation. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The presented embodiments describe, for example, methods and systems for increasing the available information associated with one or more parameter variations for a predefined set of source-receiver pairs used in seismic data acquisition. This can be accomplished by, for example, avoiding or reducing destructive contributions during processing of the data and involve, for example, computing a sensitivity kernel for a selected parameter for each source-receiver pair based on a velocity model, filtering the collection of source-receiver pairs to an area of interest, measuring the parameter variations for the filtered source-receiver pairs and inverting the parameter variations based on the sensitivity kernels adapted to the filtered source-receiver pairs.

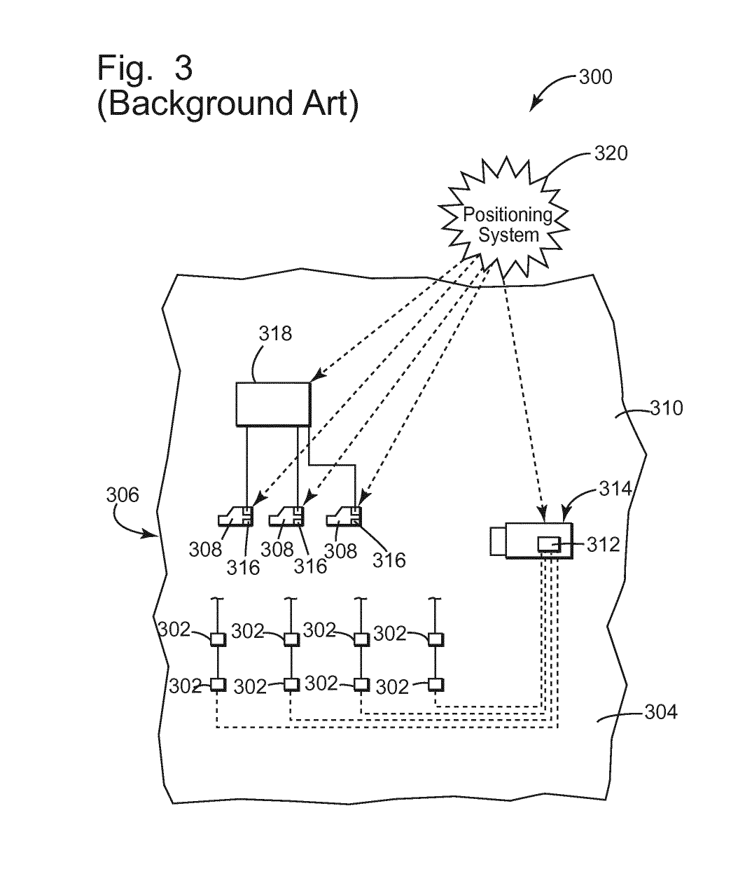

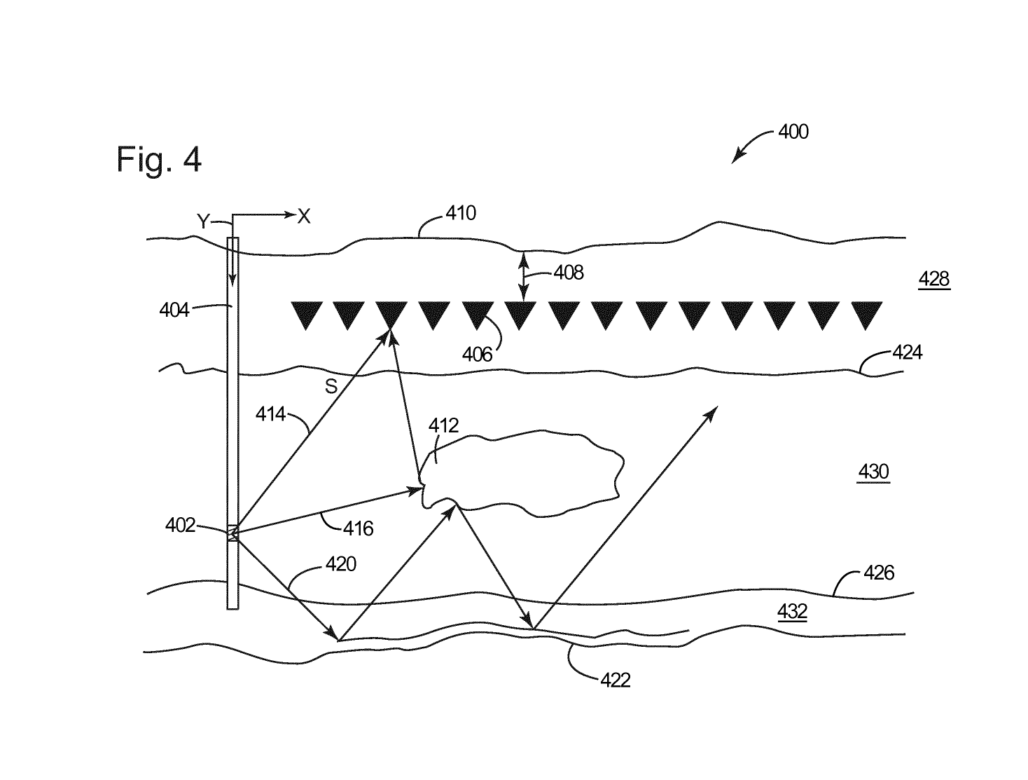

In order to provide some context for the subsequent embodiments, consider first some generalized aspects of seismic data acquisition processes and systems as will now be described with respect to FIGS. 3 and 4. A configuration for achieving seismic monitoring is illustrated in FIG. 3. The system 300 includes a plurality of receivers 302 positioned over an area 304 of a subsurface to be explored and in contact with the surface 306 of the ground. A number of sources 308 are also placed on the surface 306 in an area 310, in a vicinity of the area 304 of the receivers 302. A recording device 312 is connected to the plurality of receivers 302 and placed, for example, in a station/truck 314. Each source 308 can be composed of, for example, a variable number of vibrators, typically between one and five, and can include a local controller 316. A central controller 318 can be provided to coordinate the shooting times of the sources 308. A positioning system 320, e.g., GPS, GLONASS, Galileo or other similar systems, can be used to time-correlate the sources 308 and the receivers 302.

With this configuration, sources 308 are controlled to generate seismic waves, and the plurality of receivers 302 records waves reflected by the petroleum and/or gas reservoirs and other structures. The seismic survey can be repeated at various time intervals, e.g., months or years apart, to determine changes in the reservoirs over the selected time interval. Although repeatability of source and receiver locations is generally easier to achieve onshore, the variations caused by changes in near-surface can be significantly larger than reservoir fluid displacement, making time-lapse 4D seismic acquisition and repeatability challenging. Accordingly, variations in seismic velocity in the near-surface are a factor that impacts repeatability of 4D surveys.

Looking to FIG. 4, another seismic system 400 is illustrated which includes at least a seismic source 402 that can be provided in a well 404 or at the surface 410 (not shown). It should be noted that the source can be any known source capable of repetitive measurements, e.g., the source can be a vibrator classically used for land acquisition as well as a SeisMovie source (developed by CGG Services, France) that includes piezoelectric vibrator elements that can provide a wide bandwidth, high reliability/repeatability and emit mono-frequencies. One example comprises a plurality of receivers 406 buried at a predetermined depth 408 relative to a surface of the earth 410. It should be noted that the receivers 406 can be buried with a vertical, horizontal or inclined orientation. The predetermined depth can be a distance greater than zero and less than the depth of the reservoir. The receivers can be three-component (3C) geophones or four-component (4C), i.e., a 3C geophone and a hydrophone. However, it should be noted that other types of receivers, e.g., optical fiber sensors and distributed acoustic sensors (DAS), can be used. The reservoir or subsurface 412 to be monitored needs to be located at a depth greater than the depth of the receivers 406. It should further be noted that in another example the receivers 406 can be located at the surface 410 (not shown).

The speed of the seismic waves, as discussed later in more detail, may be estimated from recording refracted seismic waves. FIG. 4 shows a direct seismic wave 414, i.e., a wave that propagates from the source 402 directly to the receivers 406. FIG. 4 also shows reflected/refracted seismic waves 416 and 420. The refracted/refracted seismic waves 416, 420 are the result of reflections from structures 412 and 412 in the subsurface, as well as refractions which can occur at interfaces 424 and 426 between subsurface layers 428, 430 and 432. . It is noted that the direct seismic wave 414 is recorded with a small offset (i.e., the distance from the source to the receiver along X axis is small) while the reflected/refracted seismic waves 416, 420 are recorded with medium to large offsets. It should be noted in the embodiments that although land based systems are described here for context, the embodiments are also applicable to seabed and marine based systems.

With this context in mind regarding seismic data acquisition systems and methods generally, the discussion now turns to embodiments which determine sensitivity kernels associated with the acquired seismic data and use those sensitivity kernels to compute parameter variations associated with the media through which the seismic waves are travelling. Initially, it is noted that the oceanographic context presented by ITURBE1 and ITURBE2 which were described in the Background section above is specific to that environment and, accordingly, the source-receiver distance in ITURBE 1 and ITURBE 2, i.e., the offset, is more than thirty times larger than the corresponding array size, e.g., 1500 meters versus 46.5 meters. By way of contrast, embodiments described here which relate to seismic data acquisition will have proportions of the acquisition design which can be different than those used in an oceanographic context. For example, now considering a seismic instead of oceanographic context, source-receiver spacing in a seismic acquisition array can be approximately 25 meters for a target depth generally between 0.5 kilometers and 3 kilometers.

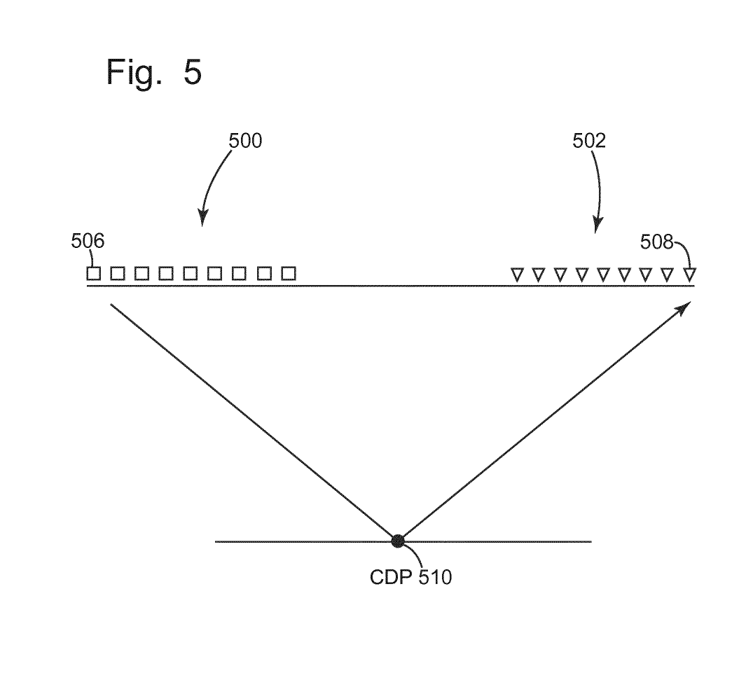

Thus it is appropriate to begin the discussion of these embodiments with a brief discussion of an exemplary seismic acquisition geometry. Looking to FIG. 5, consider two linear arrays, a source array 500 (represented by squares) and a receiver array 502 (represented by triangles), wherein each linear array comprises nine source-receiver pairs which are spread over an area to be imaged. As described above with respect to FIGS. 3 and 4, the sources 500 generate waves which are transmitted through layers in the subsurface being imaged, and the receivers 502 receive reflections and refractions of those waves. In this example, if the array distance is approximately two hundred meters for each array 500, 502, and the spacing between the sources in array 500 and between the receivers in array 502 is 25 meters, then the source-receiver distance divided by the array distance gives a ratio of approximately 7.5.

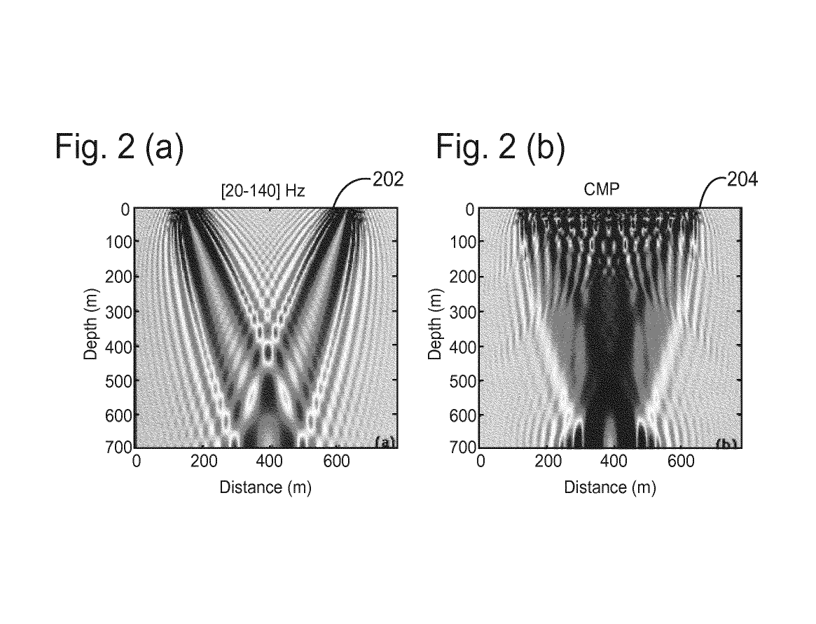

Returning now to FIGS. 2(a) and 2(b), these figures illustrate travel-time sensitivity kernels associated with the acquisition geometry of FIG. 5. For example, with reference to FIG. 2(a), depicted there is a sensitivity kernel 202 associated with a source-receiver pair from the seismic acquisition geometry of FIG. 5 at a five hundred meter offset, e.g., source-receiver pair 506, 508, and CDP 510 in FIG. 5. Additionally, FIG. 2(b) represents the time-travel sensitivity kernels of the nine CDPs derived from the nine sources 500 and nine receivers 502 of FIG. 5.

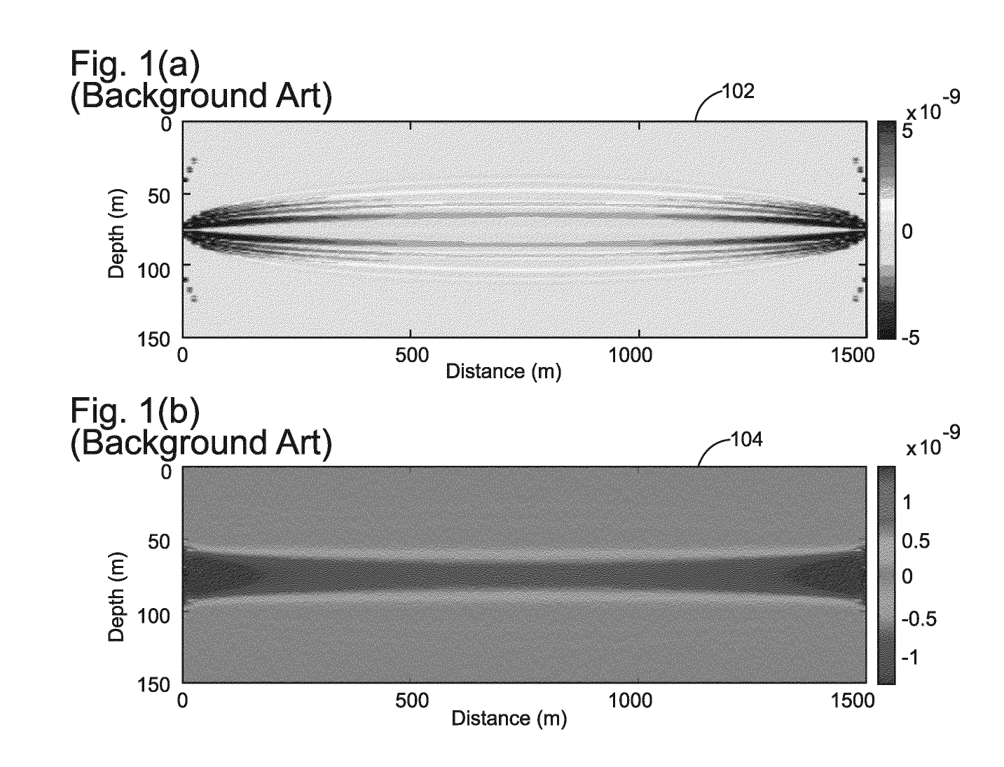

Various differences between the time-travel sensitivity kernel 102 in FIG. 1(a) (oceanographic context) and the time-travel sensitivity kernel 202 in FIG. 2(a) will be appreciated by those skilled in the art. For example, in the seismic exploration context and due to the relatively small depth/offset ratio, the sensitivity kernels are thinner in the oceanographic environment than in the seismic context. This fact suggests that the impact of the oscillations between negative, null and positive contributions is relatively more extended in the seismic context relative to the oceanographic environment.

This difference in environments associated with sensitivity kernels impacts the optimization associated with the double beamforming summation proposed by Iturbe. For example, performing a trace summation on traces acquired using a seismic acquisition system, e.g., a double-beamforming processing, will show that, for a given point of the propagation such as the selected point 510, the positive and negative contributions are mixed, resulting in cancellations that will degrade the performance of the summation, thereby resulting in less useful sensitivity kernels which don't accurately track parameter variations. The embodiments described I below allow for this mixed condition and reduce or eliminate the cancellations that degrade the performance of the summation.

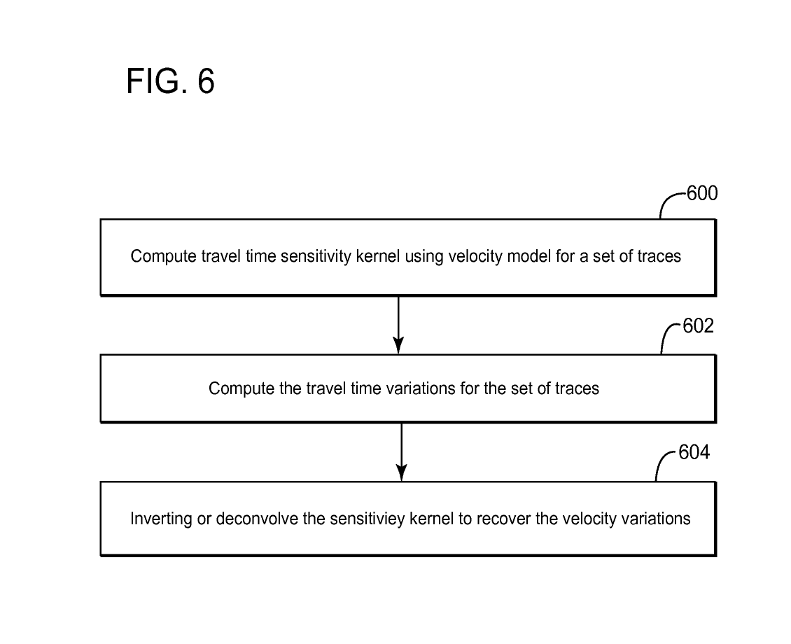

More specifically, and according to an embodiment, both the spatial dependency recognized above with respect to offset of the source-receiver pairs and the problems associated with using double beamforming summation to improve sensitivity kernels in the seismic context can be addressed using the method illustrated in FIG. 6 for the example of computing travel time variations as a parameter of interest. Therein, at step 600, the method begins with computing the time travel sensitivity kernel of the medium using a velocity model for a set of traces, e.g., source-receiver pairs, CDP or migrated traces, covering a given area at an associated depth. The travel-time variations are then computed for the set of acquired traces at step 602 directly using the acquired seismic data. Note that steps 600 and 602 can be performed in any desired order or in parallel with one another. The time-travel variations output from step 602 still suffer from the afore-noted oscillations. Accordingly, at step 604, the velocity variations within the given area are recovered by inverting or by deconvolving the computed travel-times variations with the time travel sensitivity kernel to generate the velocity variations, i.e., the variations in the subsurface parameter of interest (in this case velocity) as a function of offset distance. These variations can, for example, be used for 4D seismic monitoring, i.e., to better understand the subsurface evolution or as inputs to further seismic data processing or inversion to derive petrophysical properties evolution.

The embodiment of FIG. 6 is, of course, subject to various modifications and adjustments. For example, one potential enhancement to the embodiment comprises prioritizing a desired pattern for the sensitivity kernel, e.g., based on a computed constrained inversion of the sensitivity kernel as a depth vs. offset function of source-receiver pairs, to generate a shape sufficiently close to the desired pattern. The pattern can be chosen to maximize sensitivity in a predefined area while minimizing sensitivity in other areas, e.g., perturbed areas, and can be implemented by weighting the contributions of source-receiver pairs to the sensitivity kernel according to the selected pattern.

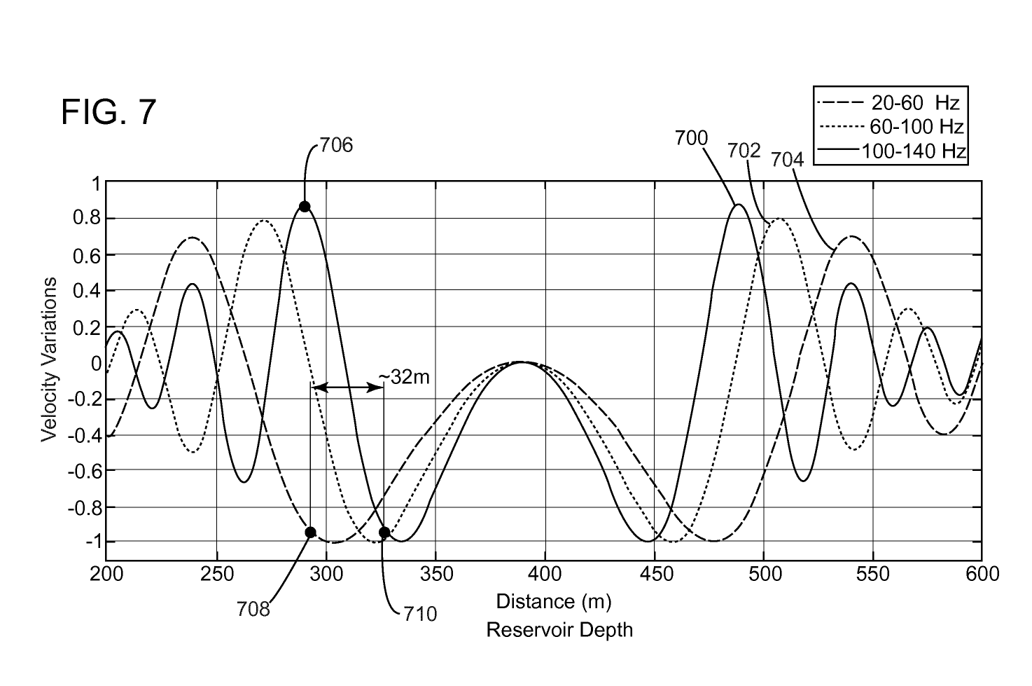

The foregoing embodiments describe, and address, spatial source-receiver/depth dependencies associated with sensitivity kernels and their associated parameter variations in seismic acquisition environments. However other embodiments also recognize that sensitivity kernels can also have frequency/depth sensitivity kernel variations. For example, and looking to FIG. 7, depicted is a representation of sensitivity kernel velocity variations as a function of reservoir depth for a CDP gather for three different frequency ranges represented by functions 700, 702 and 704. It should be noted in the Figure that, for a given depth, the lower and higher frequencies can comprise travel time variations of opposite signs. See, for example, points 706 and 708. Additionally, in this example, it can also be seen that there is a 32 m distance separating the negative peak 708 for the 20-60 Hz kernels and the negative peak 710 for the 100-140 Hz kernels or, stated differently, that the inversion polarity for 100-140 Hz kernels occurs within 32 m.

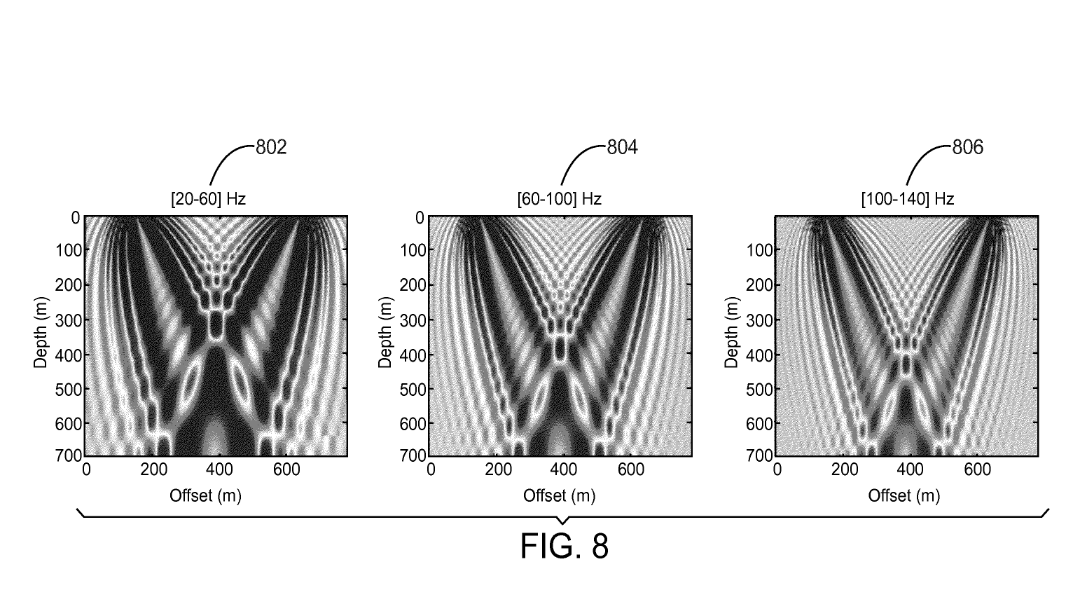

FIG. 8 illustrates the frequency dependency of sensitivity kernels in another way. Therein, a wavelet with low 802, medium 804 and high 806 frequency is propagated in the same type of medium, and the resulting velocity is plotted as a function of offset vs. depth (darker areas equal higher velocities). It should be noted in FIG. 8 that the lower bandwidth 802 is approximately 20-60 Hertz, the medium bandwidth 804 is approximately 60-100 Hertz and the higher bandwidth 806 is approximately 100-140 Hertz. It is of significance to note that for a given area in the medium the travel-time contribution and the polarity are frequency dependent for a given source-receiver pair. Thus, according to another embodiment, processing of the sensitivity kernels provides for frequency correction based on inverting the sensitivity kernels by frequency sub-bands. In one embodiment the signal is separated into different bandwidths based on the different polarizations to avoid the destructive interference associated with processing a large bandwidth. It should also be noted that the bandwidth subsets I can be processed independently to extract the information associated with the various sensitivity kernels so that more information will be available. More generally, and like the spatial dependency embodiments described above, the contributions of the source-receiver pairs to the sensitivity kernels can be weighted as a function of frequency to address the frequency dependency identified above.

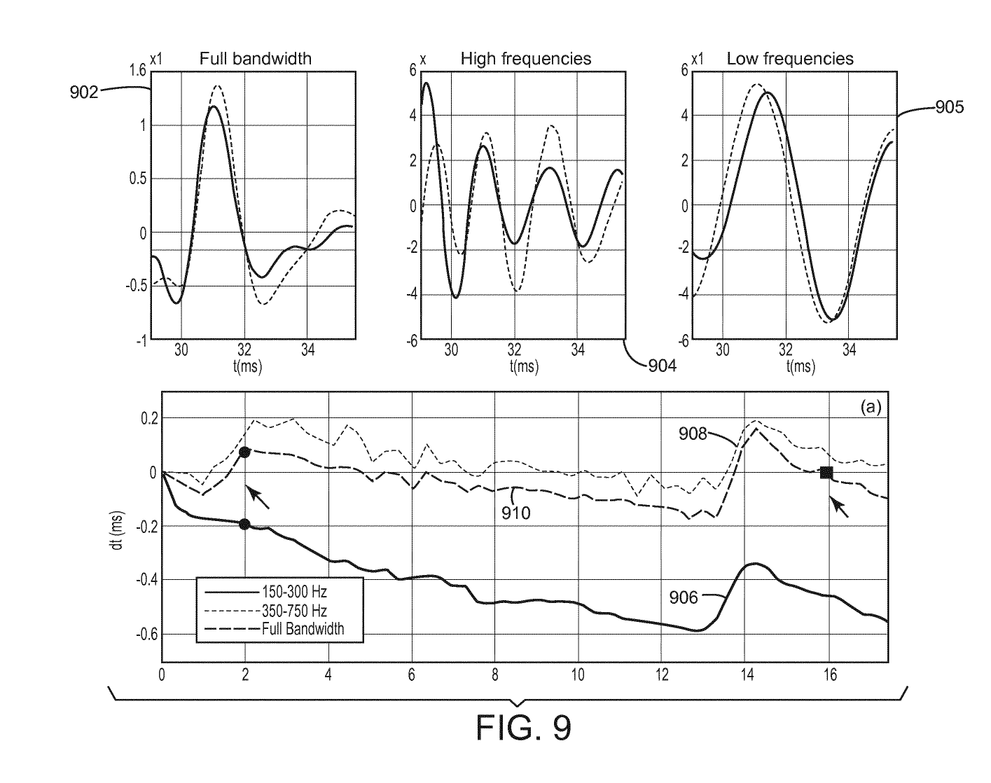

FIG. 9 also illustrates the issue of travel-time frequency dependency, computed for a single CDP as a simulation. More specifically, FIG. 9 shows the full bandwidth of a wavelet 902 at hour 0 (solid line) and hour 2 (dashed line) in the 100 Hertz to 750 Hertz bandwidth, which was selected to mimic seismic acquisition design. It should be noted in the wavelet 902 that no delay is easily observable between the hour 0 and hour 2 wavelets. Continuing with higher frequencies, e.g., 350 Hertz to 750 Hertz, it is observable in FIG. 9 that the wavelet 904 at hour 2 arrives in advance of the wavelet at hour 0 and that for lower frequencies, e.g., 150 Hertz to 350 Hertz, the wavelet 905 at hour 2 is slightly delayed relative to the wavelet at hour 0. Looking now to the bottom of FIG. 9, the arrival time variations are depicted over 17 hours and it is observable that there are opposite variations in the high 906 and the low 908 frequency bandwidth while the global variations 910 show less important variations. For example, at hour 2, it can be seen that the low bandwidth time variations 906 first decrease while at the same time the high bandwidth time variations 908 first increase. This demonstrates the usefulness of considering different bandwidths 906, 908 in the context of addressing frequency dependencies associated with parameter variations in sensitivity kernels for seismic applications.

More specifically, it can be seen that wavefield parameter variations cannot easily be detected by considering the full bandwidth 910 while separated bandwidths 906, 908 provide detection with higher sensitivity, i.e., a given velocity variation causes higher measurement variations in the sub-bandwidth. Based on this recognition of frequency dependency, various embodiments propose to perform the processing of FIG. 6 on one or more selected subsets of the acquired seismic data, wherein the subsets each contain data associated with different frequency bandwidths, so as to properly address the frequency dependent nature as well. For example, separate processing by frequency band can be useful when e.g., the medium behavior is frequency-dependent (for example, some mediums have elastic behavior at certain frequencies and visco-elastic behavior for other frequencies). It could also be useful when tracking phenomena which are more or less localized as kernel size is frequency dependent.

Various alternatives and modifications to the afore-described embodiments are also contemplated. For example, in addition to travel-time variations as described above, the embodiments can also be applied to, but are not limited to, amplitude variations, slowness variations, azimuth variations and incidence angles. As will be appreciated by those skilled in the art, the term “slowness” refers to a characteristic of a medium which is the reciprocal of velocity, i.e., such that the travel time of a seismic wave is the distance that the wave travels multiplied by the slowness of the medium. The embodiments can also be applied to any type of parameter(s) variations as soon as a sensitivity kernel can be calculated and as soon as summations are performed, e.g., beamforming, Common Depth Point Summation, etc.

Moreover, it is not always necessary to calculate the sensitivity kernel under certain circumstances, e.g., in the case of a frequency dependency, the parameter(s) variations can be detected on the data by computations for different bandwidths as described previously, which characteristic is more prominent when different bandwidths are carrying different information. Additionally, various shapes can be generated for weighting predefined geographical areas within a medium, i.e., spatial variations, temporal variations, amplitude variations and slowness or angles variations, to emphasize or de-emphasize sensitivities in those areas.

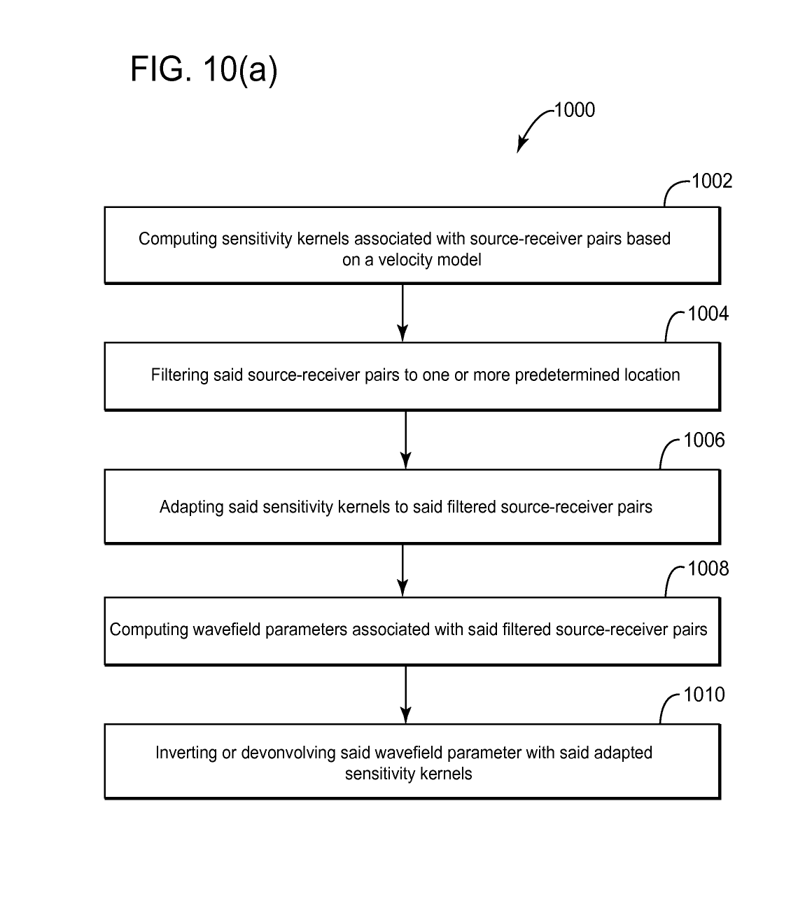

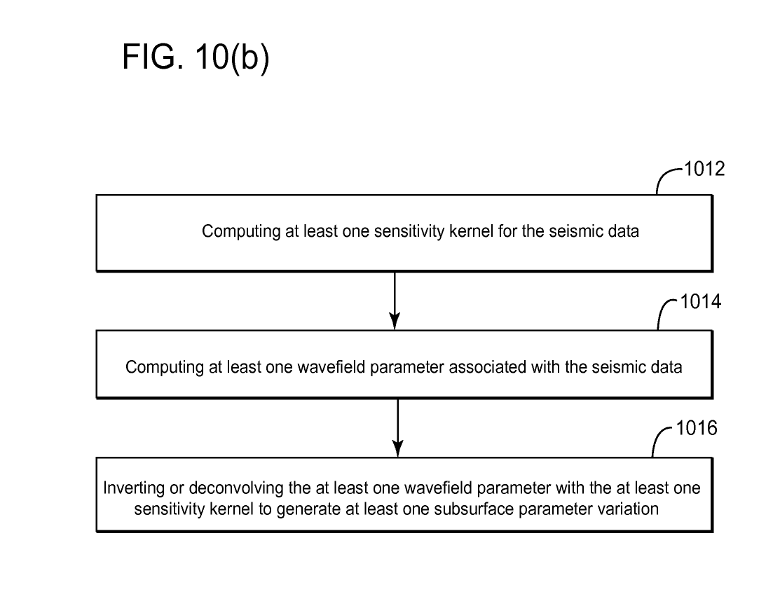

FIG. 6 illustrates a method for processing seismic data according to one embodiment. However, other embodiments can express the foregoing features more generally or more specifically. For example, and looking now to FIG. 10(a), another method embodiment 1000 for processing seismic data is depicted. Starting at step 1002, the method embodiment 1000 computes sensitivity kernels associated with source-receiver pairs based on a velocity model. Next at step 1004 of the method embodiment 1200, the source-receiver pairs are selected based on one or more predetermined locations. Continuing at step 1006 of the method embodiment 1000, the sensitivity kernels are adapted to the filtered source-receiver pairs. Further, at step 1008 of the method embodiment 1000, the wavefield parameters associated with the filtered source-receiver pairs are computed. Next at step 1010 of the method embodiment 1000, the wavefield parameters are inverted or deconvolved based with the adapted sensitivity kernels to generate subsurface parameter variations.

Another example is provided in the flowchart of FIG. 10(b). Therein, at step 1012, at least one sensitivity kernel for the seismic data is computed. At least one wavefield parameter, e.g., travel times, associated with the seismic data is computed at step 1014. Then, the at least one wavefield parameter is inverted or deconvolved with the at least one related sensitivity kernel to generate at least one subsurface parameter variation.

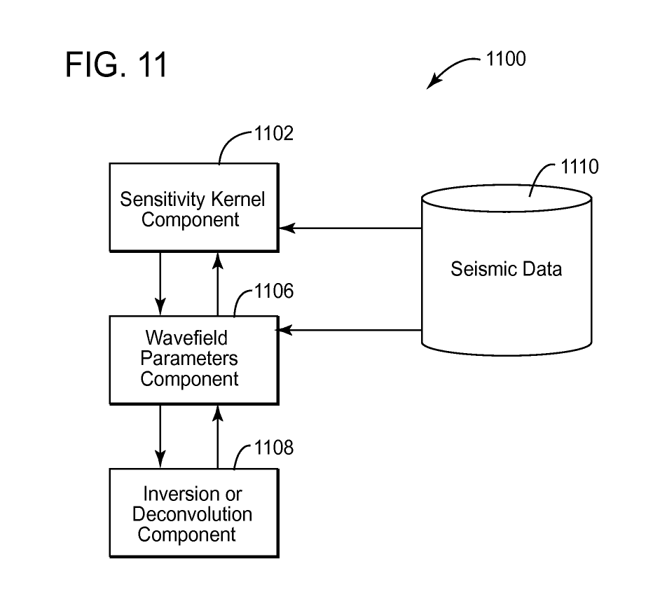

The methods described above can, for example, be implemented as combinations of hardware and software operating on suitable computing devices having one or more processors and memory devices including Looking now to FIG. 11, a schematic diagram of a system 1100 for processing seismic datasets in accordance with one or more of the foregoing methods is depicted. The system 1100 comprises a sensitivity kernel component 1102, a wavefield parameters component 1106, an inversion or deconvolution component 1108 and a seismic dataset 1110. The sensitivity kernel component 1102 provides the capability to compute sensitivity kernels for the seismic dataset 1110. It should be noted in the system 1100 that the sensitivity kernel can be computed for source-receiver pairs, common depth-point (CDP) collections and migrated collections. It should further be noted that sensitivity kernels can be computed for each of one or more frequency bands, as described earlier.

The wavefield parameters component 1106 provides the capability for computing wavefield parameters based on the seismic data 1110. It should be noted in the embodiment that examples of the wavefield parameters comprise travel-time, amplitude and slowness. The inversion or deconvolution component 1108 provides the capability to invert or deconvolve the wavefield parameter with the related sensitivity kernels to generate the desired subsurface parameter variations, e.g., velocity

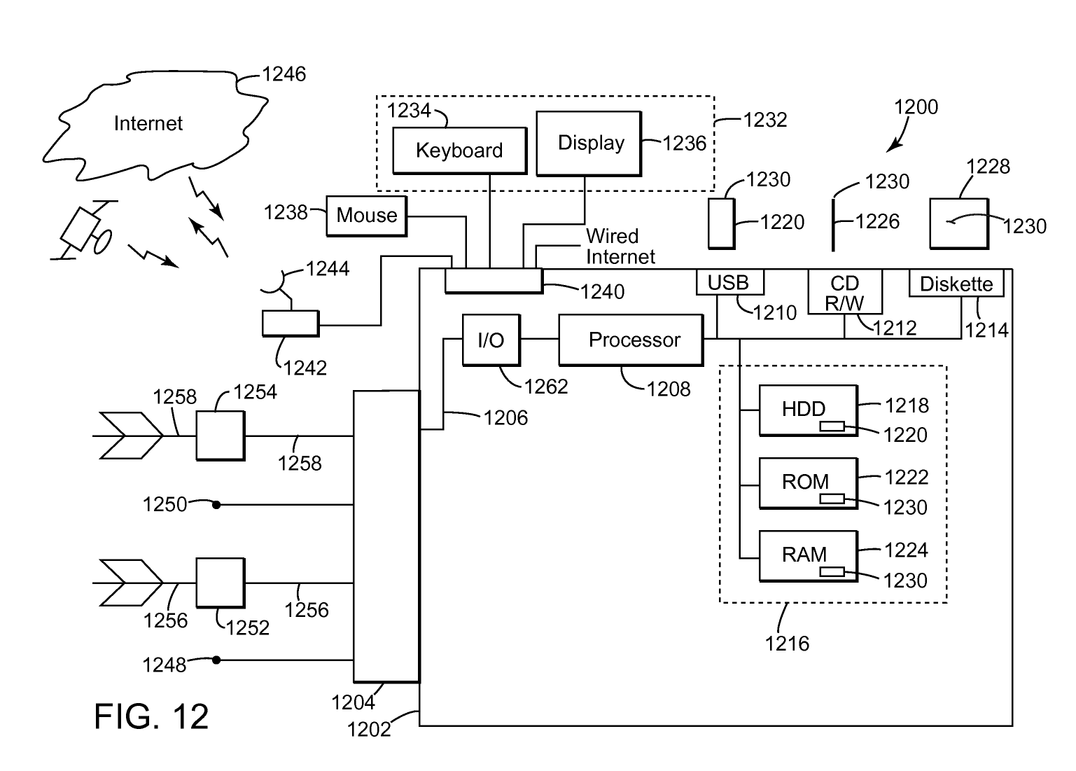

The computing device(s) or other network nodes involved in multi-component dip filtering of ground roll noise as set forth in the above described embodiments may be any type of computing device capable of processing and communicating seismic data associated with a seismic survey. An example of a representative computing system capable of carrying out operations in accordance with these embodiments is illustrated in FIG. 12. System 1200 includes, among other items, server 1202, source/receiver interface 1204, internal data/communications bus (bus) 1206, processor(s) 1208 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 1210, compact disk (CD)/digital video disk (DVD) read/write (R/W) drive 1212, floppy diskette drive 1214 (though less used currently, many servers still include this device), and data storage unit 1216.

Data storage unit 1216 itself can comprise hard disk drive (HDD) 1218 (these can include conventional magnetic storage media, but, as is becoming increasingly more prevalent, can include flash drive-type mass storage devices 1220, among other types), ROM device(s) 1222 (these can include electrically erasable (EE) programmable ROM (EEPROM) devices, ultra-violet erasable PROM devices (UVPROMs), among other types), and random access memory (RAM) devices 1224. Usable with USB port 1210 is flash drive device 1220, and usable with CD/DVD R/W device 1212 are CD/DVD disks 1226 (which can be both read and write-able). Usable with diskette drive device 1214 are floppy diskettes 1228. Each of the memory storage devices, or the memory storage media (1218, 1220, 1222, 1224, 1226, and 1228, among other types), can contain parts or components, or in its entirety, executable software programming code (software) 1230 that can implement part or all of the portions of the method described herein. Further, processor 1208 itself can contain one or different types of memory storage devices (most probably, but not in a limiting manner, RAM memory storage media 1224) that can store all or some of the components of software 1230.

In addition to the above described components, system 1200 also comprises user console 1232, which can include keyboard 1234, display 1236, and mouse 1238. All of these components are known to those of ordinary skill in the art, and this description includes all known and future variants of these types of devices. Display 1236 can be any type of known display or presentation screen, such as liquid crystal displays (LCDs), light emitting diode displays (LEDs), plasma displays, cathode ray tubes (CRTs), among others. User console 1232 can include one or more user interface mechanisms such as a mouse, keyboard, microphone, touch pad, touch screen, voice-recognition system, among other inter-active inter-n communicative devices.

User console 1232, and its components if separately provided, interface with server 1202 via server input/output (I/O) interface 1240, which can be an RS232, Ethernet, USB or other type of communications port, or can include all or some of these, and further includes any other type of communications means, presently known or further developed. System 1200 can further include communications satellite/global navigation satellite system (GNSS)/global positioning system (GPS) transceiver device 1242, to which is electrically connected at least one antenna 1244 (according to an embodiment, there would be at least one GPS receive-only antenna, and at least one separate satellite bi-directional communications antenna). System 1200 can access internet 1246, either through a hard wired connection, via I/O interface 1240 directly, or wirelessly via antenna 1244, and transceiver 1242.

Server 1202 can be coupled to other computing devices, such as those that operate or control the equipment of truck 112 of FIG. 1, via one or more networks. Server 1202 may be part of a larger network configuration as in a global area network (GAN) (e.g., internet 1246), which ultimately allows connection to various landlines.

According to a further embodiment, system 1200, being designed for use in seismic exploration, will interface with one or more sources 1248, 1250 and one or more receivers 1252, 1254. As further previously discussed, sources 1248, 1250 and receivers 1252, 1254 can communicate with server 1202 either through an electrical cable that is part of streamer 1256, 1258, or via a wireless system that can communicate via antenna 1244 and transceiver 1242 (collectively described as communications conduit 1260).

According to further exemplary embodiments, user console 1232 provides a means for personnel to enter commands and configuration into system 1200 (e.g., via a keyboard, buttons, switches, touch screen and/or joy stick). Display device 1236 can be used to show: source/receiver 1256, 1258 position; visual representations of acquired data; source 1248, 1250 and receiver 1252, 1254 status information; survey information; and other information important to the seismic data acquisition process. Source and receiver interface unit 1204 can receive the seismic data from receiver 1252, 1254 though communication conduit 1260 (discussed above). Source and receiver interface unit 1204 can also communicate bi-directionally with sources 1248, 1250 through the communication conduit 1260. Excitation signals, control signals, output signals and status information related to source 1248, 1250 can be exchanged by communication conduit 1260 between system 1200 and source 1248, 1250.

Bus 1206 allows a data pathway for items such as: the transfer and storage of data that originate from either the source sensors or receivers through an I/O processor 1262 ; for processor 1208 to access stored data contained in data storage unit memory 1216; for processor 1208 to send information for visual display to display 1236; or for the user to send commands to system operating programs/software 1230 that might reside in either the processor 1208 or the source and receiver interface unit 1204.

System 1200 can be used to implement the methods described above associated with multi-component dip filtering of ground roll noise according to an exemplary embodiment. Hardware, firmware, software or a combination thereof may be used to perform the various steps and operations described herein. According to an exemplary embodiment, software 1230 for carrying out the above discussed steps can be stored and distributed on multi-media storage devices such as devices 1218, 1220, 1222, 1224, 1226, and/or 1228 (described above) or other form of media capable of portably storing information (e.g., universal serial bus (USB) flash drive 1220). These storage media may be inserted into, and read by, devices such as the CD-ROM drive 1212, the disk drive 1214, among other types of software storage devices.

The disclosed exemplary embodiments provide a server node, and a method for multi-component dip filtering of ground roll noise associated with seismic depth images. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method, stored in a memory and executing on a processor, for seismic data processing, said method comprising:
computing at least one sensitivity kernel related to at least one wavefield parameter associated with said seismic data;
computing the at least one wavefield parameter associated with said seismic data; and
inverting or deconvolving said at least one wavefield parameter with said at least one sensitivity kernel to generate at least one subsurface parameter variation.

2. The method of claim 1, wherein said at least one wavefield parameter is travel-times associated with waves travelling between source-receiver pairs in a seismic acquisition system and said at least one sub-surface parameter variation is velocity variations between said source-receiver pairs raypaths.

3. The method of claim 1, wherein said sensitivity kernels are computed using a velocity model.

4. The method of claim 1, wherein said seismic data is based on a Common Depth-point (CDP) collection.

5. The method of claim 1, wherein said seismic data is based on a migrated collection.

6. The method of claim 1, wherein said seismic data is associated with a predefined subset of source-receiver pairs.

7. The method of claim 1, further comprising:
separating said seismic data into sets of data associated with different frequency bands; and
performing the steps of computing and inverting or deconvolving on one or more of the sets of data.

8. The method of claim 1, further comprising:
weighting contributions of source-receiver pairs to the seismic data according to a selected pattern.

9. A method, stored in a memory and executing on a processor, for processing seismic data, said method comprising:
computing sensitivity kernels associated with source-receiver pairs based on a velocity model;
filtering said source-receiver pairs to a predetermined location;
adapting said sensitivity kernels to said filtered source-receiver pairs;
computing wavefield parameters associated with said filtered source-receiver pairs; and
inverting or deconvolving said wavefield parameters with said adapted sensitivity kernels to derive at least one subsurface parameter variation.

10. The method of claim 9, wherein said predetermined wavefield parameter is travel-time.

11. The method of claim 9, wherein said predetermined wavefield parameter is amplitude.

12. The method of claim 9, wherein said predetermined wavefield parameter is slowness.

13. The method of claim 9, further comprising:
separating said seismic data into sets of data associated with different frequency bands; and
performing the steps of computing and inverting or deconvolving on one or more of the sets of data.

14. A system for processing seismic data, said system comprising:
a seismic dataset;
one or more processors configured to execute computer instructions and a memory configured to store said computer instructions wherein said computer instructions further comprise:
a sensitivity kernel component for computing at least one sensitivity kernel based on said seismic dataset;
a wavefield parameter component for computing at least one wavefield parameter based on said seismic dataset; and
an inversion or deconvolution component for inverting or deconvolving said at least one wavefield parameter with said at least one sensitivity kernel to generate at least one subsurface parameter variation.

15. The system of claim 14, wherein said one or more processors are further configured to separate said seismic dataset into sets of data associated with different frequency bands, and wherein the inversion or deconvolution component is further configured to operate on one or more of the sets of data.

16. The system of claim 14, wherein said at least one wavefield parameter is travel-times associated with waves travelling between source-receiver pairs in a seismic acquisition system and said at least one sub-surface parameter variation is velocity variations between said source-receiver pairs ray paths.

17. The system of claim 14, wherein said sensitivity kernels are computed using a velocity model.

18. The system of claim 14, wherein said seismic dataset is based on a Common Depth-point (CDP) collection.

19. The system of claim 14, wherein said seismic dataset is based on a migrated collection.

20. The system of claim 14, wherein said seismic dataset is associated with a predefined subset of source-receiver pairs.
